(19) United States
(12) Patent Application Publication
(10) Pub. No.: US 2012/0046989 A1
(43) Pub. Date: Feb. 23, 2012

(54) SYSTEMS AND METHODS FOR DETERMINING RISK OUTLIERS AND PERFORMING ASSOCIATED RISK REVIEWS

(75) Inventors: Igor A. Baikalov, Thousand Oaks, CA (US); Dan P. Antilley, JR., Fort Mill, SC (US); Jonathan William Deats, Dallas, TX (US); Robert Alan Hansen, Laveen, AZ (US); Peter Jordan Langsam, New York City, NY (US); Cris T. Paltenghe, Spirit Lake, ID (US); Ravi Pritmani, Irving, TX (US); Chadwick R. Renfro, Dallas, TX (US); Carmen M. Warn, Manalapan, NJ (US)

(73) Assignee: BANK OF AMERICA CORPORATION, Charlotte, NC (US)

(21) Appl. No.: 13/013,695

(22) Filed: Jan. 25, 2011

Related U.S. Application Data
(60) Provisional application No. 61/374,481, filed on Aug. 17, 2010.

(51) Int. Cl. G06Q 10/00

(52) U.S. Cl. 705/7.28

(57) ABSTRACT

Embodiments of the invention relate to risk review assessments and, more particularly to determining risk review candidates by identifying two or more community categories, determining risk scores for each user/employee across risk categories, normalizing the risk scores based on community averages and community standard deviations and determining risk review candidates by comparing the normalized risk scores to predetermined thresholds. In additional embodiments, an outlier reinforcement score for each user/employee by summing all of the positive-valued normalized risk scores across the two or more communities and comparing the outlier reinforcement score to a predetermined threshold.

### CLAIM OF PRIORITY UNDER 35 U.S.C. §119

The present application for patent claims priority to Provisional Application No. 61/374,481 entitled “System and Methods for Determining Risk Outliers and Performing Associated Risk Reviews” filed Aug. 17, 2010, and assigned to the assignee hereof and hereby expressly incorporated by reference herein.

### FIELD

In general, embodiments of the invention relate to risk assessment and, more particularly, determining risk outliers, identifying risk review candidates based on the risk outliers and performing the corresponding risk assessments.

### BACKGROUND

Access entitlements are permissions granted at various levels within an entity, such as a corporate enterprise or the like, to allow an individual, such as an employee to perform a given type of task. Depending on the entity granting the access entitlements and the individuals to whom the access entitlements are granted, the permissions can be at a highly granular level. For example, a user/employee may have read-only access entitlement to a specific document and/or the user/employee may have read and write access to another specific document.

In addition, access entitlements can be grouped into hierarchies based on groups and assigned to roles. For example, a specific employee role is granted read-only access entitlement to a specific document and/or read and write access entitlement to another document. Members of the specific employee group have the specific employee role and all members of the group may have group-wide access entitlements and/or all employees having the same role may have role-wide access entitlements. The use of such roles makes individual entitlements easier to manage since a large collection of granular entitlements can be associated to a role. Groups are then assigned to the role, and finally employees are given membership to the groups. Simply by adding an employee to a group will grant that employee all of the entitlements necessary to perform the functions of the role.

Some job functions may have many roles that are necessary to perform the duties of the job. Additionally, access to multiple computers, shared folders, network domains, etc. may be necessary. To make the on-boarding of new or transferred employees more manageable, many on-boarding procedures have been automated, such that large number of access entitlements that have been pre-defined by a job function may be granted to the new or transferred employee.

Over time, a given employee can acquire a large number of access entitlements by changing job capacities if the original entitlements granted to the employee are not cancelled, referred to herein as “de-provisioned”. Although de-provisioning entitlements when the access is no longer generally required is an industry best practice, the fact that there is a strong correlation with length of employment and the number of entitlements outstanding indicates that current de-provisioning procedures are highly ineffective.

In large corporations, the ineffectiveness of de-provisioning procedures, are due, at least in part, to the reality that the correlation between job functions, roles to support functions, entitlements to support roles, and the relationships to an employee's current job requirements are typically poorly maintained. This disconnect in the de-provision practices is primarily due to the sheer scale of the number of access entitlement applications, the age of the access entitlement applications, the disparate platforms and the manner in which the platforms maintain entitlements, disconnection between on-boarding and de-provisioning systems, and the velocity of change imposed on all of the factors results in a problem that is very difficult to retroactively resolve.

Access entitlement reviews need to be performed within enterprises on a regular basis to ensure employees have access to what they need to perform their job functions, but no more access than is necessary. Such access reviews serve to reduce the risk of possible inappropriate usage. In certain regulated industries access entitlement reviews, conducted on a regular basis, are not only an industry best practice; such reviews are now required by government policy and regulators, such as Sarbanes-Oxley and the like.

In the past access reviews have been scheduled on a calendar basis. Most best-practice frameworks, such as Control Objectives for Information and related Technologies (COBIT) or the like, recommend that access entitlement reviews be conducted on a regularly scheduled basis, the frequency of which depends on the nature of the entitlements. Entitlements that represent a greater risk, such as those that allow employees to view customer or third party identities, should be reviewed more frequently, while lower risk entitlements, such as those that provide employees access to the corporate network, may be reviewed less frequently. However, calendar or other cyclic regularly scheduled reviews tend to be arbitrary and have no correlation to when risk conditions occur.

Unfortunately, many access entitlements are not classified by risk, and, therefore, conducting such access reviews based on risks becomes problematic. Further, because of the issues discussed previously, it is usually not even possible to conduct access reviews by job title, job functions or roles because the association to these higher level groupings does not exist or no longer exists.

Traditionally, access reviews have resulted in an attempt to review all of the entitlements for all of the employees. In an enterprise scenario, such an exhaustive review puts an impractical amount of work and responsibility on the managers of the employees. In addition, poor effectiveness and efficiency of the access reviews can be attributed to the scale of entitlements granted within an enterprise. Moreover, due to inadequate information describing the entitlements, the managers do not readily understand the nature of the entitlements, or the implications of de-provisioning the entitlements. In this regard, managers all too often continue to provide perfunctory approvals of entitlements rather than take the risk of disabling important functions that may negatively impact their staff.

In addition, access entitlement reviews and, specifically the goal of risk reduction, provide for difficulty in terms of quantitative measurement and demonstration.

Therefore, a need exists to develop systems and method for access entitlement reviews that demonstrate and measure a reduction in risk. In addition, the desired access entitlement review system and methods should reduce the workload of managers or other individuals typically tasked with conducting such reviews. Additionally, the desired systems and methods should increase effectiveness of the reviews as evidenced by the percentage of access reviews completed and improved reduction of risk by higher revocation percentages versus traditional reviews. Moreover, the desired access entitlement review systems and methods should increase efficiency by reviewing only those entitlements that represent the most risk.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Thus, further details are provided below for determining risk review candidates based on risk outliers and performing corresponding risk reviews. The process of risk review candidate identification based on risk outlier determination is initiated by identifying two or more community categories within the entity. In specific embodiment, two community categories are identified, herein referred to as the community category pair. The first community category within the pair being characteristically broad and the second community category within the pair being characteristically narrow. Each community category includes multiple communities, which are subsets of the overall entity, e.g., the overall employee base. In the community category pair embodiment, each user/employee within the entity must belong to both community categories within the community category pair, having a single community membership within each community category, each community representing a different grouping. Examples of community categories within a corporate enterprise include job title/job code, organizational hierarchy and the like. Examples of a community category pair are (1) job title and (2) organizational hierarchy.

Once community categories have been identified, one or more risk scores are determined for the users/employees of the entity/corporate enterprise. Each of the risk scores are associated with a risk category, defined based on the needs of the entity/corporate enterprise. In specific embodiments, the risk categories include, but are not limited to, access, behavior and export. Once the risk scores have been determined, community averages and community standard deviations are determined for each community category and each risk category.

Once the community averages and community standard deviations are determined, the risk scores are normalized. In specific embodiments, normalization may include determining standard z-scores for each user/employee for each combination of community and risk category.

Community category scores can be determined for each community category by summing the positive valued normalized risk scores within the community category and an outlier reinforcement score can be determined by summing all of community category scores.

Risk review candidates can be identified by comparing a user/employee's normalized risk scores to predetermined normalized risk score thresholds and/or comparing the outlier reinforcement score to a predetermined outlier reinforcement threshold.

Additional embodiments of the invention provide for a flexible, continuously monitored and scalable access entitlement risk review model based on access risk scoring of employees in an enterprise and focusing on outliers identified by inappropriate access, past behavior and/or export capability.

The access entitlement model described herein relies on various observations, guidelines and assumptions. These observations, guidelines and assumptions include, but are not limited to, (1) not all entitlements are equal, some entitlements represent more risk than others; (2) not all entitlements need to be reviewed, or reviewed continuously, only those entitlements that represent the most risk are worthy of access review; (3) entitlements that are common for a given job should be de-emphasized in the access review because they most likely essential to the job; (4) the more unusual the entitlement, the higher the likelihood that is either unnecessary or represents elevated risk, as such, focus on the most unusual entitlements first; (5) an unusual entitlement can be determined by comparing a given employee's entitlements to what is common for the their job function and/or the group they are assigned to; (6) statistical analysis techniques can be employed to determine true outliers with a specified level of confidence; (7) entitlements that are deemed unusual for a given job should be justifiable or should be revoked; (8) the actual employees possess more information regarding specific entitlement necessity than their managers; (9) employees can assist in clarifying inadequate entitlement descriptive information; (10) employees pre-review of entitlements can reduce manager workload and reduce the likelihood of perfunctory entitlement approval; (11) if managers are presented with information about the employee's behavior and ability to export data from the enterprise, the managers will make more enlightened decisions regarding the appropriateness of access entitlements; and (12) if specific entitlements can be risk rated, then reduction of risk can be measured as a function of entitlement revocations resulting from a review.

A method for risk review candidate determination defines first embodiments of the invention. The method includes identifying two or more community categories within an entity. The method further includes determining, via a computing device processor, for a plurality of employees associated with the entity, one or more raw risk scores. Each raw risk score is associated with a risk category. Additionally, the method includes determining, via a computing device processor, community averages and community standard deviations for each community within the community categories based on the one or more raw risk scores. Further, the method includes determining, via a computing device processor, for the plurality of employees, one or more normalized risk scores. Each normalized risk score is based on a raw risk score and associated with a risk category and a community. Lastly, the method includes determining, via a computing device processor, one or more risk review candidates from amongst the plurality of employees by comparing the normalized risk scores to predetermined normalized risk score thresholds.

In specific embodiments the method further includes determining, via a computing device processor, for each of the plurality of employees, an outlier reinforcement score. In specific embodiments, the outlier reinforcement score is determined by summing all of the positive-valued normalized risk scores within a community to result in an overall community score and summing all of the overall community scores to result in the outlier reinforcement score. In such embodiments of the method, determining the one or more risk review candidates further includes determining, via a computing device processor, the one or more risk review candidates by comparing the outlier reinforcement score to a predetermined outlier reinforcement score threshold.

In further specific embodiments of the method, identifying further includes identifying two community categories within the entity, wherein a first community category is characteristically broad and a second community category is characteristically narrow. In other specific embodiments of the method, identifying further includes identifying two community categories within the entity (i.e., a community category pair), wherein each community category includes a plurality of communities and each of the plurality of employees belongs to both community categories within the community category pair, having a single community membership within each community category, each community representing a different grouping.

In still further specific embodiments of the method, determining the one or more raw risk scores further includes determining, via the computing device processor, for the plurality of employees associated with the entity, the one or more raw risk scores, wherein each raw risk score is associated with a risk category and the risk categories include access, behavior and export.

In other specific embodiments of the method, determining the plurality of normalized risk scores further includes determining, via the computing device processor, for the plurality of employees, the plurality of normalized risk scores, wherein the normalized risk scores are standard z-scores. In other related embodiments of the method, determining the plurality of normalized risk scores further includes determining, via the computing device processor, for the plurality of employees, the plurality of normalized risk scores, wherein the normalized risk score for a risk category equals the difference between a raw risk score and the community average divided by the community standard deviation.

An apparatus for risk review candidate determination defines second embodiments of the invention. The apparatus includes a computing platform including a memory and at least processor in communication with the memory. The apparatus further includes a risk outlier module stored in the memory and executable by the processor. The module includes one or more risk category score routines configured to determine, for a plurality of employees associated with an entity, a raw risk score. Additionally, the module includes a community average and standard deviation routine configured to determine, community averages and community standard deviations for each community within two or more identified community categories. The community averages and community standard deviations are determined based on the raw risk score. In addition, the module includes a risk score normalization routine configured to determine, for the plurality of employees, one or more normalized risk scores. Each normalized risk score is based on a raw risk score and associated with a risk category and a community. Moreover, the module includes a risk review candidate determination routine configured to determine one or more risk outliers from amongst the plurality of employees by comparing the normalized risk scores to predetermined normalized risk score thresholds.

In specific embodiments of the apparatus, the module further includes an outlier reinforcement routine configured to determine, for each of the plurality of employees, an outlier reinforcement score. The outlier reinforcement score is determined by summing all of the positive-valued normalized risk scores within a community to result in an overall community score and summing all of the overall community scores to result in the outlier reinforcement score. In such embodiments, the risk review candidate determination routine is further configured to determine the one or more risk review candidates by comparing the outlier reinforcement score to a predetermined outlier reinforcement score threshold.

In other specific embodiments of the apparatus, the community average and standard deviation routine is further configured to determine community averages and community standard deviations for each community within two identified community categories, wherein a first community category is characteristically broad and a second community category is characteristically narrow. In still further embodiments of the apparatus, the community average and standard deviation routine is further configured to determine community averages and community standard deviations for each community within two identified community categories, wherein each community category comprises a plurality of communities and each of the plurality of employees belong to one community within the community category.

Moreover, in other specific embodiments of the apparatus, the one or more risk category score routines configured are further configured to determine a raw access risk score, a raw behavior risk score and raw export risk score.

In still further embodiments of the apparatus, the risk score normalization routine is further configured determine, for the plurality of employees, the plurality of normalized risk scores, wherein the normalized risk scores are standard z-scores. In still further related embodiments, the risk normalization routine is further configured to determine, for the plurality of employees, the plurality of normalized risk scores, wherein the normalized risk score for a risk category equals the difference between a raw risk score and the community average divided by the community standard deviation.

A computer program product including a non-transitory computer-readable medium defines third embodiments of the invention. The computer-readable medium includes a first set of codes for causing a computer to determine, for a plurality of employees associated with the entity, one or more raw risk scores. Each raw risk score is associated with a risk category. The computer-readable medium also includes a second set of codes for causing a computer to determine community averages and community standard deviations for each community within two or more identified community categories based on the one or more raw risk scores. Further, the computer-readable medium includes a third set of codes for causing a computer to determine, for the plurality of employees, one or more normalized risk scores. Each normalized risk score is based on a raw risk score and associated with a risk category and a community. Moreover, the computer-readable medium includes a fourth set of codes for causing a computer to determine one or more risk review candidates from amongst the plurality of employees by comparing the normalized risk scores to predetermined normalized risk score thresholds.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference may now be made to the accompanying drawings:

FIG. 1 is a is block diagram of a risk outlier module, in accordance with embodiments of the present invention;

FIG. 2 is a block diagram of various risk category score routines, in accordance with embodiments of the present invention;

FIG. 3 is a flow diagram of a method for determining risk review candidates, in accordance with embodiments of the present invention;

FIG. 4 is flow diagram of a method for determining risk review candidates risk assessment review, in accordance with present embodiments of the invention;

FIG. 5 is a flow diagram of a method for conducting risk review assessments, in accordance with present embodiments;

FIG. 6 is a user interface display in a system for risk assessment review, in accordance with embodiments of the present invention;

FIG. 7 is another user interface display in a system for risk assessment review, in accordance with embodiments of the present invention;

FIG. 8 is another user interface display in a system for risk assessment review; in accordance with embodiments of the present invention;

FIG. 9 is a user interface display in a system for risk assessment review, highlighting risk score detail; in accordance with embodiments of the present invention;

FIG. 10 is a user interface display in a system for risk assessment review, highlighting risk score detail; in accordance with embodiments of the present invention;

FIG. 11 is another user interface display in a system for risk assessment review, in accordance with embodiments of the present invention;

FIG. 12 is another user interface display in a system for risk assessment review, in accordance with embodiments of the present invention;

FIG. 13 is a bar graph illustrating proof of the effectiveness of inventive concepts; in accordance with embodiments of the present invention;

FIG. 14 is a bar graph illustrating proof of the effectiveness of inventive concepts; in accordance with embodiments of the present invention; and

FIG. 15 is a bubble chart illustrating the higher level of confidence of determining risk outliers by utilizing the present invention, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

As may be appreciated by one of skill in the art, the present invention may be embodied as a method, system, computer program product, or a combination of the foregoing. Accordingly, the present invention may take the form of an entirely software embodiment (including firmware, resident software, micro-code, etc.) or an embodiment combining software and hardware aspects that may generally be referred to herein as a “system.” Furthermore, embodiments of the present invention may take the form of a computer program product on a computer-readable medium having computer-usable program code embodied in the medium.

Any suitable computer-readable medium may be utilized. The computer-readable medium may be, for example but not limited to, an electronic, magnetic, optical, electromagnetic, or semiconductor system, apparatus, device, or propagation medium. More specific examples of the computer readable medium include, but are not limited to, the following: a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

Computer program code for carrying out operations of embodiments of the present invention may be written in an object oriented, scripted or unscripted programming language such as Java, Perl, Smalltalk, C++, SAS or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

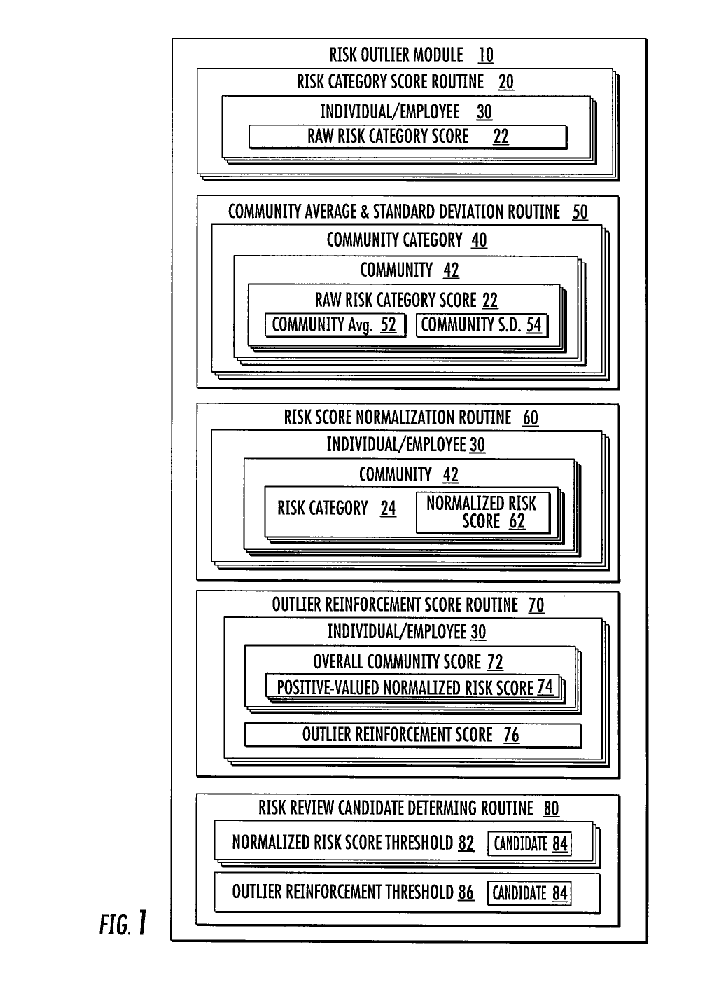

FIG. 1 is a block diagram of a risk outlier module 10 that is configured to determine individuals, typically employees, as risk outliers within an entity, such as a business, corporation, enterprise or the like. The risk outlier module 10 includes one or more risk category score routines 20, community average and standard deviation routine 50, risk score normalization routine 60, outlier reinforcement score routine 70 and risk review candidate determining routine 80.

Risk category score routines 20 are configured to determine a raw risk category score 22 for each user/employee 30 within the entity. The entity implementing the risk outlier module 10 can define risk categories and the manner by which scores are determined based on their security requirements, risk tolerances and the like. Therefore, the risk categories selected, the volume of risk categories, and the manner by which risk scores are determined within a category should not be viewed as limiting to the inventive concepts herein disclosed.

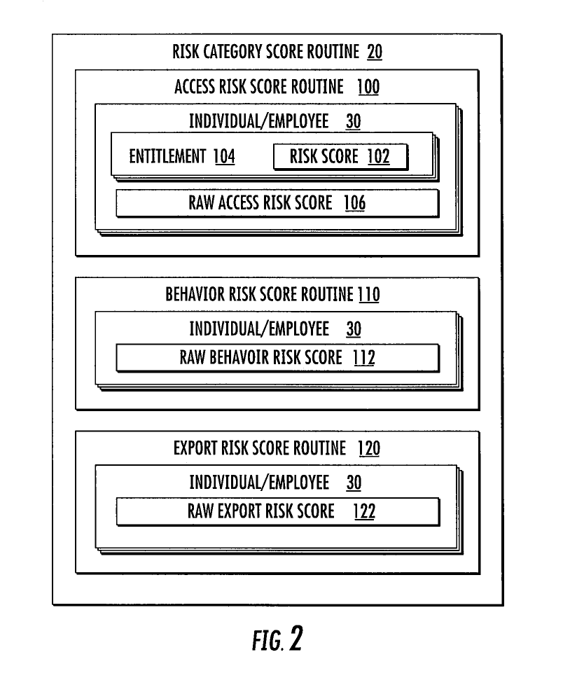

In one specific embodiment of the invention, as discussed in more detail in relation to FIG. 2 infra., the risk categories are defined as (1) access, i.e., the entitlements granted to the user/employee; (2) behavior, i.e., the actions taken by the user/employee that could elevate risk; and (3) export, i.e., the user's/employee's ability to move data out of the entity. However, as noted above, other entities may define less or more risk categories and/or different risk categories.

Community average and standard deviation routine 50 is configured to determine community averages 52 and community standard deviations 54 for the plurality of communities 42 within a selected community category 40 based on the raw risk category scores 22 associated with the community 42. Each community category 40 includes multiple communities 42, which are subsets of the overall entity, e.g., the overall employee base. Each user/employee within the entity belongs to each of the community categories 40 and belongs to one, and one only, of the communities 42 within the community category 40. The community average 52 and community standard deviation 54 serve as that community's baseline for that particular risk category. In order to determine a risk outlier (i.e., a user/employee having unusual risk or risk outside of the norm), a user's/employee's normalized risk scores need to be compared to a community baseline.

In accordance with embodiments of the present invention, community categories 40 will vary depending on the entity, such as a company/corporation/enterprise or the like. In one specific embodiment of the invention, two or more community categories 40 within the entity are selected by the entity. Further, the selected community categories 40 should characteristically be reasonable adequate for clustering access entitlement similarities. Moreover, in specific embodiments, in which two community categories 40 are selected, the first community category 40 should be broad in scope and the second community category 40 should be narrow in scope so that statistical extremes are covered for the purpose of determining outliers.

For example, in one specific embodiment of the invention, in which two community categories 40 are selected, referred to herein as a community category pair, the first community category within the pair is job code/job title and the second community category within the pair is organizational hierarchy. In large corporations/enterprises or the like, job code/job title tends to be a broad community category, i.e., one community/job code within the community category may have a large number of users/employees. If a community is large, the likelihood of employees having similar attributes, such as entitlements or the like, is small, as such only those attributes that are common to the community would appear as normal, whereas all other attributes would tend to appear as outliers. Conversely, in large corporations/enterprises or the like, organizational hierarchy tends to be a narrow community category, i.e., one community/hierarchy within the community category may be limited to as few as one user/employee. If a community is small, everything occurring within the community tends to be viewed as “normal”. In the instance in which an organizational hierarchy community is defined by a single user/employee, the user's/employee's raw risk category scores are equal to the average, and therefore there is no deviation from the norm.

Risk score normalization routine 60 is configured to determine user/employee normalized risk scores 62 for each risk category 24 and for each community 42. In one specific embodiment of the invention, the normalized risk scores 62 are standard z-scores implemented in conventional statistical analysis. The normalized risk scores 62 indicate how many standard deviations a raw risk score is away from the baseline average it is being compared to. In specific embodiments, the normalized risk score equals the difference between raw risk category score 22 and the community average 52 for the risk category 24 divided by the community standard deviation 54 for the risk category 24. Therefore, in the embodiment in which in which two community categories are selected: (1) job code/title; and (2) organizational hierarchy, and three risk categories are defined (1) access; (2) behavior; and (3) export, six normalized risk scores 62 are determined for each user/employee 30, i.e., (1) access/job code/title normalized risk score; (2) access/organizational hierarchy normalized risk score; (3) behavior/job code/title normalized risk score; (4) behavior/organizational hierarchy normalized risk score; (5) export/job code/title normalized risk score; and (6) export/organization hierarchy normalized risk score.

The outlier reinforcement score routine 70 is configured to determine an outlier reinforcement score 76 for each individual/employee 30. The outlier reinforcement score 76 is the function that combines an individual/employee's normalized risk scores 62 across all risk categories 24 and community categories 40 to increase confidence levels in the determination of outliers. First, an overall community score 72 is determined for each individual/employee 30 by summing all of the positive-valued normalized risk scores 74 for each risk category 24 within the community 42. Only positive-valued scores are implemented in the determination so that a real risk is not hidden when one or more of the score components happen to be sub-normal, i.e., a negative-valued normalized risk score. Once overall community scores 72 have been determined, an outlier reinforcement score 76, is determined by summing all of the overall community scores 72. For example, in those embodiments in which two community categories 40 are implemented (e.g., job code and hierarchy) and three risk categories 24 are implemented (e.g., access, behavior, and export), an overall community score 72 is determined for each of the two community categories by summing the positive-valued normalized risk scores 62 for the three risk categories within the community. Once an overall community score 72 is determined for both the job code community category and the hierarchy community category, the two overall community scores 72 are summed to result in the outlier reinforcement score 76.

The risk review candidate determination routine 80 is configured to determine risk review candidates 84, which are the basis for subsequent access entitlement review. Outliers may be determined by comparing the normalized risk scores 62 for each user/employee 30 to corresponding predetermined normalized risk score thresholds 82 and/or comparing the outlier reinforcement score 76 to a predetermined outlier reinforcement threshold 86.

Determining the predetermined normalized risk score thresholds 82 and the outlier reinforcement threshold 86 are imperative to properly identifying risk review candidates. Moreover, the thresholds may be adjusted for specific communities and/or specific access entitlement reviews.

In specific embodiments of the invention, normalized risk scores 62 exceeding a threshold of 1.0 have been used to identify reasonable confidence in outlier/risk review candidate status. Normalized risk scores 62 exceeding a threshold of 3.0 sigma have been used to identify high confidence in outlier/risk review candidate status. However, it should be noted that such threshold values are company/corporation/enterprise or industry specific and may not apply to all applications of the inventive concepts herein disclosed.

It should be noted that the risk outlier module 10 shown and described in FIG. 1 encompasses some, but not all, embodiments of the present invention. Other outlier modules that determine other attribute outliers besides risk outliers are also contemplated and within the inventive concepts herein disclosed. In such embodiments, attribute raw score are determined across one or more attribute categories; community averages and community standard deviations are determined across the attribute categories for two or more community categories; normalized attribute scores are determined based on the raw attribute scores, community averages and community standard deviations; outlier reinforcement scores are determined for various community categories and attribute outliers are determined based on comparison of the normalized attribute scores to predetermined thresholds and comparison of the outlier reinforcement scores to predetermined thresholds.

FIG. 2 provides a block diagram of various exemplary risk category score routines 20; in accordance with further embodiments of the invention. As previous noted. The type of risk categories, the volume of risk categories and/or the manner in which a risk category is scored will depend upon the risk requirements of the entity implementing the risk outlier determination mechanism of the present invention.

The risk categories included in FIG. 2 are based on the assumption that risk can be conceptually defined as:

R₍ᵤₛₑᵣ₎=[Σ(e·Wₑ)]·UA·[1/C]
where,
R₍ᵤₛₑᵣ₎=the total risk for an user/employee;
e=entitlement to a single resource;
Wₑ=an adjusted weighted risk for the entitlement based on exposure;
UA=the user's/employee's probability of committing future negative impact based on past actions;
C=complexity required to expose information once obtained.

Based on the risk formula, the three risk categories include (1) access, i.e., entitlements granted to an individual employee); (2) behavior, i.e., actions of the user/employee that could elevate risk, and (3) export, i.e., the ability of the user/employee to move physical and/or non-physical assets (e.g., information, data or the like) out of the company, enterprise, entity or the like. Within the risk score module 20 each of the risk categories 24 are scored independently according to their specific context.

Access risk score routine 100 is configured to determine an access risk score 102 for each entitlement 104 granted to a user/employee 30 within the entity. Each access risk score 102 is based on a platform class of the entitlement and an application risk score for the application/document associated with entitlement and the user/employee. An overall raw access risk score 106 may be determined by summing each of the access risk scores 102.

Behavior risk score routine 110 is configured to determine a single raw behavior risk score 112 for the user/employee 30 at a specific point in time. Behavior risk scores 112 are based on various employee activities, such as, but not limited to, web access/traffic to malicious/data manipulation websites, data movement to removable media, electronic mail (email) sent or blocked that include non-public information, non-public information stored locally on employee's computing device, mainframe activity and the like. Additionally, behavior risk scores 112 are based on employee trends, such as, but not limited to, spikes in typical activity, average activity being higher than the entities average, off-hours activity and the like. In addition, the behavior risk scores 112 are based on employee classifications, including, but not limited to, whether the user/employee is a contractor or a regulated user/employee.

Behavior risk scores 112 are determined using activity from a predetermined prior period, for example, the last thirty days or the like. Additionally, behavior risk scores 42 may be determined on a regularly scheduled basis, such as daily or the like. In specific embodiments, the employee activities, trends and classifications are weighted based on how suspicious or potentially harmful the activity, trend or classification may be.

Export risk score routine 120 is configured to determine a raw export risk score 122 for the user/employee 30 at a specific point in time. The export capabilities, which are the basis for the export risk score 122, are determined by user/employee exceptions to bypass blocking controls. The export exceptions may include exceptions related to physical and/or non-physical assets. For example, the export exceptions may include, but are not limited to, access to write to removable media/storage, access to web-based email accounts, unfiltered access to the Internet, access to certain hardware, such as laptop computers, and the like.

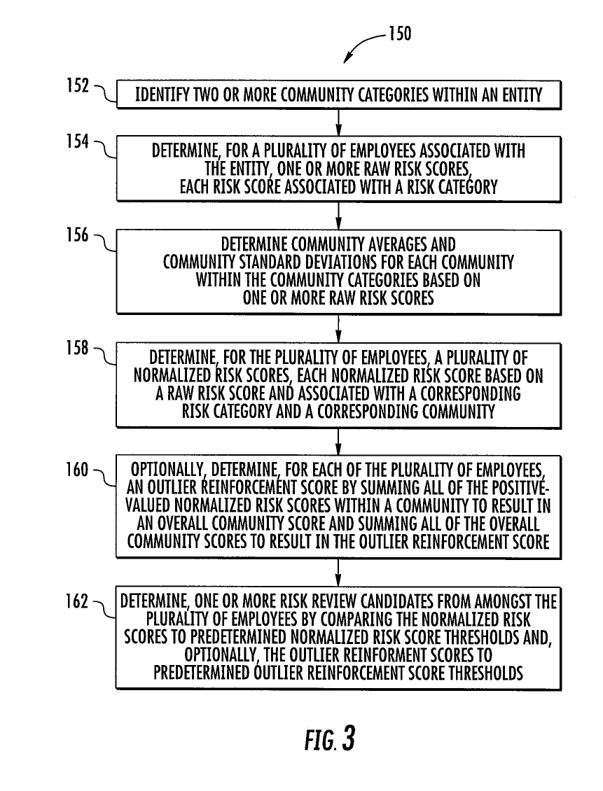

Referring to FIG. 3 a flow diagram is presented of a method 150 for risk outlier determination, in accordance with embodiments of the present invention. At Event 152, two or more community categories are identified within an entity. A community category is defined herein as a classification in which each of the users/employees associated with the entity belong to (i.e., are classified in) one, and one only, community (i.e., grouping) within the classification. In one specific embodiment of the method, two community categories are identified, referred to herein as a community pair. Moreover, in other specific embodiments, in which a community pair is identified, the first community category within the community pair is a characteristically broad category and the second community category within the community pair is a characteristically narrow category. Such disparity in the two community categories assures that risk outliers are properly determined. In a specific example, discussed herein, a characteristically broad community category is job code or job title and a characteristically narrow community category is organizational hierarchy. It should be noted that job code/job title and organizational hierarchy are examples only and should not be construed as limiting to the inventive concepts herein disclosed.

At Event 154, a one or more raw risk scores are determined for each of the plurality of users/employees associated with the entity. Each of the one or more risk scores is associated with a risk category. As previously discussed, in one specific embodiment, the risk categories may include, but are not limited to, access risk, behavior risk and export risk. It should also be noted that since the risk scores are raw risks that will subsequently be normalized, the defined risk categories, the basis for determining the scores, the parameters and attributes used to determine the scores and the like are not pertinent to the inventive concepts herein disclosed.

At Event 156, community averages and community standard deviations are determined for each community within the community categories and for each risk category based on the one or more raw risk scores. As previously noted, the community average and community standard deviation serve as that community's baseline for a particular risk category. In order to determine a risk outlier (i.e., a user/employee having unusual risk or risk outside of the norm), a user's/employee's normalized risk scores needs to be compared to a community baseline.

At Event 158, one or more normalized risk scores are determined for each of the plurality of users/employees associated with the entity. Each normalized risk score is based on a raw risk score and associated with a corresponding risk category and a corresponding community. In one specific embodiment of the invention, the normalized risk scores are standard z-scores implemented in conventional statistical analysis. The normalized risk scores provide an indication of how many standard deviations a raw risk score is away from the baseline average it is being compared to. In specific embodiments, the normalized risk score equals the difference between raw risk score for a risk category and the community average for the risk category divided by the community standard deviation for the risk category.

At optional Event 160, an outlier reinforcement score is determined for each of the plurality of users/employees associated with the entity. In specific embodiments, the outlier reinforcement score is determined by summing all of the positive-valued normalized risk scores for each risk category within a community to result in an overall community score and summing all of the overall community scores to result in the outlier reinforcement score. Only positive-valued normalized risk scores are implemented in the determination so that a real risk is not hidden when one or more of the score components happen to be sub-normal, i.e., a negative-valued normalized risk score.

At Event 162, one or more risk review candidates are determined from amongst the plurality of users/employees by comparing the normalized risk scores to predetermined normalized risk score thresholds and, in those embodiments of the method which utilize outlier reinforcement scores, comparing the outlier reinforcement scores to predetermined outlier reinforcement score thresholds. If the normalized risk scores or outlier reinforcement scores meet or exceed the predetermined corresponding threshold, a risk review candidate is determined to exist.

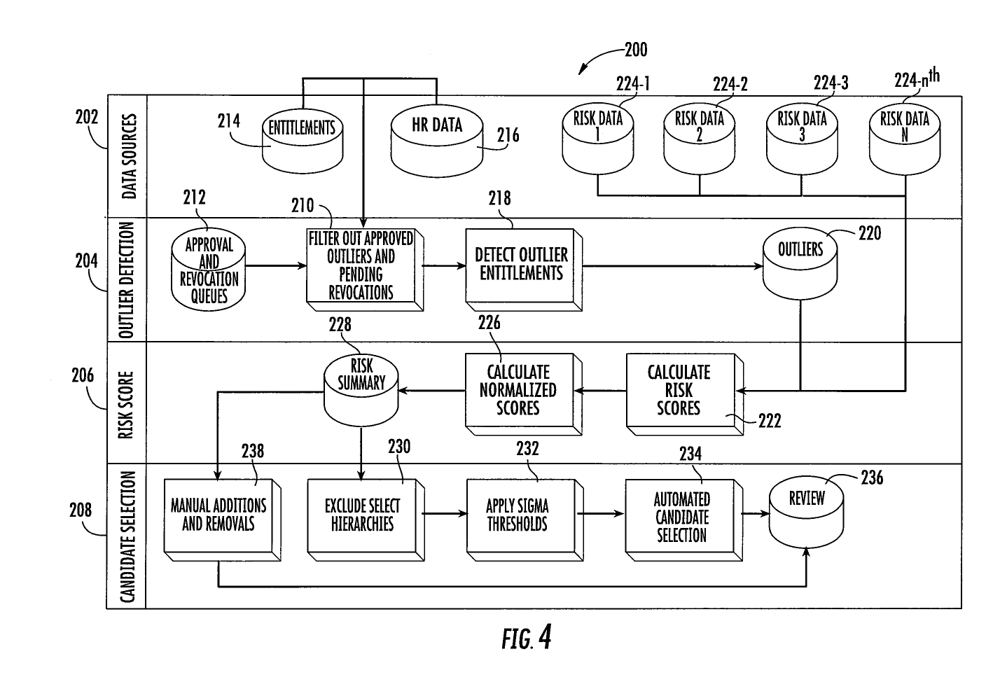

FIG. 4 provides for a flow diagram of a method 200 for outlier determination and, more specifically risk scoring and risk candidate review selection; in accordance with embodiments of the present invention. FIG. 4 illustrates the flow chart in terms of horizontal “swim lanes” associated with various phases of the method 200 and the data sources implemented in the method 200. Thus, data source “swim lane” 202 depicts the various data sources implemented in the method 200. Outlier detection “swim lane” 204 depicts the events in the outlier detection phase of the method 200, risk score “swim lane” 206 depicts the events in the risk score phase of the method 200 and candidate selection “swim lane” 208 depicts the events in the candidate selection phase of the method 200.

Beginning at Event 210, within the outlier detection “swim lane” 204, listings of previous approved outliers and pending revocations are received from the approval queue and revocation queue 212 and are subsequently filtered out from the overall listings of entitlements and users/employees, received from the entitlement/access control data source 214 and the user/employee data source 216. The approval queue and revocation queue represent data from previous outlier detection, risk scoring and candidate selection processing. Specifically, the approval queue represents previously detected outliers that were approved during later assessments and the revocation queue represents previously identified entitlement revocations that are currently pending. The approved outliers and pending revocations are filtered out from the overall lists of entitlements and users/employees, prior to conducting the outlier detection, to eliminate redundancy in reviewing approved outliers and revoking previously revoked entitlements.

At Event 218, high-level outlier detection occurs based on a predetermined threshold percentage of likelihood that an entitlement is an outlier. The outlier detection serves to filter the overall entitlement database prior to determining risk scores. In one specific embodiment of the invention, the predetermined threshold percentage is defined as sixty-eight percent (68%), such that, entitlements having a 68% or greater likelihood of being an outlier are subjected to subsequent risk scoring and risk outlier determination. Conventional statistics have shown that entitlements having an outlier likelihood of 68% or greater are at least one standard deviation away from the mean of the population. The result of the high-level outlier detection is the outlier queue 220, which is subjected to subsequent risk scoring and lower-level outlier detection.

At Event 222, within the risk score “swim lane” 206, risk scores are calculated for the outliers in the high-level outlier queue 220. The risk scores are determined based on risk data determined from multiple risk data sources 224-1, 224-2, 224-3 and 224-nth within the entity. As previously discussed risk scores may be calculated for one or more risk categories. Risk categories and the related risk score determination may be specific to the entity determining risk outliers, as such the quantity and type of risk categories and the method by which risk is scored for any one risk category are not germane to the inventive concepts herein disclosed and, thus may vary accordingly. In one specific embodiment of the invention, the risk categories may include behavior, access and export.

At Event 226, the risk scores are standardized, otherwise referred to as normalized, by determining risk category community averages and risk category community standard deviations for each community within a predetermined community category. As previously noted, the community average and standard deviation serve as that community's baseline for a particular risk category. In order to determine a risk outlier (i.e., a user/employee having unusual risk or risk outside of the norm), a user's/employee's normalized risk scores needs to be compared to a community baseline. Corresponding normalized risk scores are subsequently determined based on the risk scores determined at Event 222 and the associated corresponding risk category and a corresponding community. As previously noted, in one specific embodiment of the invention, the normalized risk scores are standard z-scores implemented in conventional statistical analysis. The normalized risk scores provide an indication of how many standard deviations a raw risk score is away from the baseline average it is being compared to. In specific embodiments, the normalized risk score equals the difference between the risk score for a risk category and the community average for the risk category divided by the community standard deviation for the risk category. In addition, outlier reinforcement scores are determined for a user/employee by summing all of the positive-valued normalized risk scores for each risk category within a community to result in an overall community score and summing all of the overall community scores to result in the outlier reinforcement score.

The risk scoring, risk score normalization and outlier reinforcement scoring, results in a risk summary queue 228. In one specific embodiments of the invention, the risk summary is user/employee-based and includes normalized risk scores for each risk category and the community within each community category that the user/employee is associated with, as well as, the user's/employee's outlier reinforcement score.

At Event 230, within the candidate selection “swim lane” 208, predetermined hierarchies may be excluded from the risk candidate review process. Predetermined hierarchies, for example, predetermined groups or segments of an organization may be excluded for the purpose of limiting the scope of the risk review process. In other embodiments, in which the entire organization, enterprise, entity or the like is subject to the risk review process, the need to exclude predetermined hierarchies may not be required.

At Event 232, predetermined thresholds, such as sigma thresholds may be applied to the normalized risk scores and the outlier reinforcement scores to determine risk review candidates. In specific embodiments of the invention, four-sigma, five-sigma or the like may be selected as the predetermined threshold for normalized risk scores and/or outlier reinforcement scores, such that scores meeting or exceeding the four-sigma, five sigma or the like threshold will provide for risk review candidate selection. At Event 234, based on normalized risk scores, the outlier reinforcement scores and the corresponding applied thresholds, automated candidate selection provides for selecting candidates for risk review and placing the candidates into the risk review queue 236 for subsequent risk review processing, as detailed in FIG. 4.

At Event 238, manual additions and/or deletion can be made to the candidate risk review list. As shown, the manual addition and/or deletion of risk review candidates may occur after completion of risk scoring (Queue 228) but prior to application of score thresholds (Event 232). In other instances, manual addition and/or deletion of risk review candidates after the application of the thresholds (Event 232) and automated risk review candidate selection (Event 234). In still further instances, manual addition and/or deletion of risk review candidates may occur after the risk review candidates have been placed in the risk review candidate queue 236.

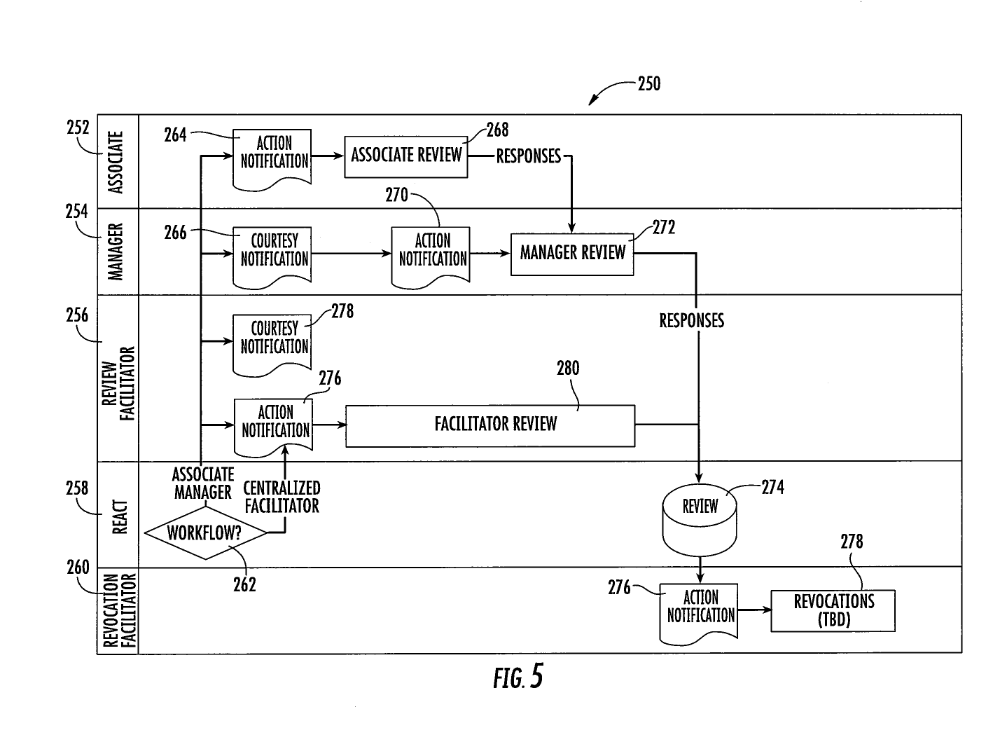

FIG. 5 provides for a flow diagram of a method 250 for risk/entitlement review assessment, in accordance with embodiments of the present invention. FIG. 5 illustrates the flow chart in terms of horizontal “swim lanes” associated with various phases of the method 250 and the corresponding entity tasked with implementing the events/processes of the method 250. Thus, associate “swim lane” 252 depicts events conducted by or associated with the associate/employee who is undergoing risk/entitlement review. Manager “swim lane” 254 depicts the events conducted by or associated with the manager of the associate who is undergoing risk/entitlement review. Review facilitator “swim lane” 256 depicts the events conducted by or associated with a review facilitator. Automated risk review “swim lane” 258 depicts the events conducted by or associated with the automated risk/entitlement review portion of the method 250. Revocation facilitator “swim lane” 260 depicts the events conducted by or associated with an entitlement revocation facilitator.

At Decision 262, a workflow decision is made within the automated risk review process. If the workflow is the initial associate/manager workflow, at Event 264, a notification requiring action is sent to the associate undergoing risk/entitlement review and, concurrent with Event 264, at Event 266 a courtesy (i.e., non-action) notification is sent to the associate's manager notifying the manager that a risk/entitlement review has been initiated for the specified associate. At Event 268, once the associate has received the notification, the associate is tasked with conducting a self-review of their entitlements, in which the associate verifies the need to continue possessing entitlement(s) and/or request revocation of entitlement(s) no longer deemed necessary. If the associate deems entitlements necessary, the associate may also be required to provide one or more reasons for requiring the entitlement. Associate self-reviews are instrumental in providing the manager with insight as to the need for the associate to maintain or revoke an entitlement. In this regard, the legwork provided by the associates during self-reviews result in time savings at the managerial end. In certain embodiments of the invention, the associate is allotted a predetermined period of time to conduct the self-review, for example within five days or the like. Once the associate has completed the self-review, the associate communicates, via the system, the self-review responses to the manager.

At Event 270, a notification requiring action is sent to the manager that informs the manager of the need to perform a manager level risk/entitlement review of the associate. The notification requiring action is sent proximate in time to the completion by the associate of their self-review and/or proximate in time to the completion of the allotted predetermined period of time for the associate to conduct the self-review. Once the manager has received the self-review from the associate via the system, at Event 272, the manager is tasked with conducting a review of the associate's entitlements, in which the manager makes a definitive decision on the associate's need to continue possessing entitlement(s) and/or a decision to revoke entitlement(s). In certain embodiments of the invention, the manager is allotted a predetermined period of time to conduct the manager-level review, for example within five days or the like. Once the manger has completed the entitlement review, the risk/entitlement responses are communicated to the review queue 274, which stores review results.

If, at decision 262 a determination is made that the workflow is the centralized facilitator workflow, at Event 276, a notification requiring action is sent to the review facilitator requiring the review facilitator to conduct a risk/entitlement review for a specified associate. In addition to the notification requiring action, at Event 278, a courtesy notification may be sent to a supporting/managerial facilitator and/or the associate's manager notifying the same that a risk/entitlement review is being initiated. The centralized facilitator workflow is undertaken in the event the associate and/or manager workflow is not appropriate or can not be conducted. In certain instances it may not be appropriate or feasible to contact the associate and/or the associate's manager to conduct a risk/entitlement review. In such instances, the review facilitator, otherwise referred to as a review proxy, is contacted to conduct the risk/entitlement review. It should be noted that while the illustrated embodiment of the centralized facilitator workflow does not require an associate review, in other embodiments and associate review may be conducted and used in conjunction with the facilitator review.

At Event 280, the review facilitator conducts the risk/entitlement review for the specified associate. In certain embodiments of the invention, the review facilitator is allotted a predetermined period of time to conduct the risk/entitlement review, for example within ten days or the like. In specific embodiments of the invention the time allotted to the review facilitator is equal to the cumulative time allotted to the associate and manager to conduct both the associate self-review and the manager review. By allotting equal time to the review facilitator and the associate/manager, the facilitator reviews and associate/manager reviews can occur in parallel with equivalent schedules.

The risk/entitlement review queue 274 receives review responses from both the managers and the facilitators based on the workflow assigned to the risk/entitlement review. The risk entitlement review queue 272 stores risk/entitlement review results, including entitlements that are to remain active and entitlements that are marked for revocation, as well as a time stamp reflecting the date/time of the risk/entitlement review.

At Event 276, a notification requiring action is sent to a revocation facilitator (i.e., a de-provisioner), who is responsible for performing the necessary actions to revoke, or otherwise referred to as de-provision, entitlements. At Event 278, the revocation of entitlements requiring revocation occurs. It should be noted that in certain embodiments the revocation facilitator is required to communicate with system managers who are ultimately responsible for revoking the entitlements. Thus, in specific embodiments of the invention, the automated review process may further include monitoring of the revocation requests for the purpose of tracking when revocations occur and when the entitlement actually is removed.

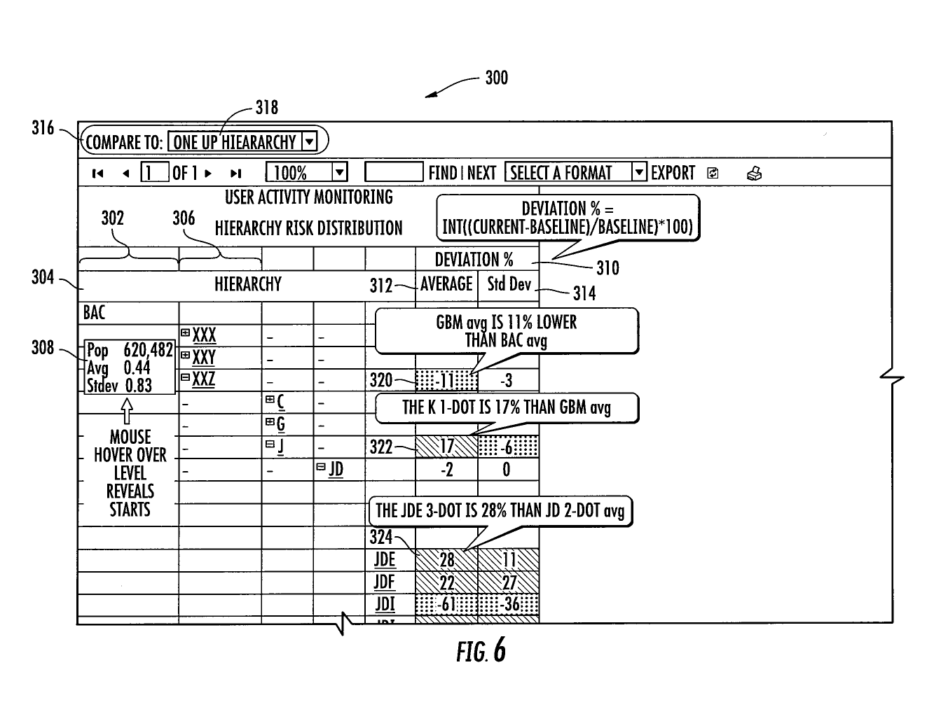

Referring to FIG. 6, shown is a graphical user interface display 300 in a system for risk assessment review, in accordance with an embodiment of the present invention. Specifically, FIG. 6 demonstrates how organization risk can be mapped to identify where the most risk resides in the entity, such as a corporation, enterprise or the like. Further, the graphical user interface display depicts how rules can be written to select candidates based on thresholds. In the illustrated example, organizational hierarchy has been selected as a community category. The furthest left column 302 under the hierarchy heading 304 represents the highest level in the organization hierarchy, i.e., the entity, corporation, enterprise or the like. The second furthest left column 306 under the hierarchy heading 304 represents the next highest level in the organization hierarchy and so forth proceeding left to right. A user may mouse hover over a community hierarchy to reveal risk related statistics 308, such as the population in the community, the community average and the community standard deviation. In addition, each community/level listed in a hierarchy provides a link to a high risk user list for that particular community/level.

The deviation percentage heading 310 provides for average deviation percentage 312 and standard deviation percentage 314. The average deviation percentage is defined as: current-baseline average divided by baseline average of the community being compared to, with the quotient being multiplied by one-hundred to provide for a percentage. The standard deviation percentage is defined as: current-baseline standard deviation divided by baseline standard deviation of the community being compared to, with the quotient being multiplied by one-hundred to provide for a percentage. The graphical user interface display 300 includes a comparison selector 316 in the upper left-hand corner that provides for the user to select the level of hierarchy for comparison, i.e., the ability to make comparisons to different community baselines. In the illustrated example, “One Up Hierarchy” has been selected from the drop-down menu 318 and, as such, each level in the organizational hierarchy is being compared to the level immediately above it on a percentage basis.

Thus, based on the selected “One Up Hierarchy,” the “GBM” community average 320 is shown to be eleven percent lower than the parent hierarchy, “entity” average. Further, the “J” community average 322 is shown to be seventeen percent higher than the parent hierarchy, “GBM” average. Moreover, the “JDE” community average 324 is shown to be twenty-eight percent higher than the parent hierarchy, “JD” average, and so on.

In the illustrated example of FIG. 6, thresholds have been set at five percent, such that average deviation percentage 312 and standard deviation percentage 314 entries greater than five percent above average are indicated by a cross-hatching pattern, average deviation percentage 312 and standard deviation percentage 314 entries greater than five percent below average are indicated by a dot pattern and all other average deviation percentage 312 and standard deviation percentage 314 entries are indicated by no pattern. A rule for automated selection would operate in a similar manner, selecting the entries represented the cross-hatching pattern as risk review candidates.

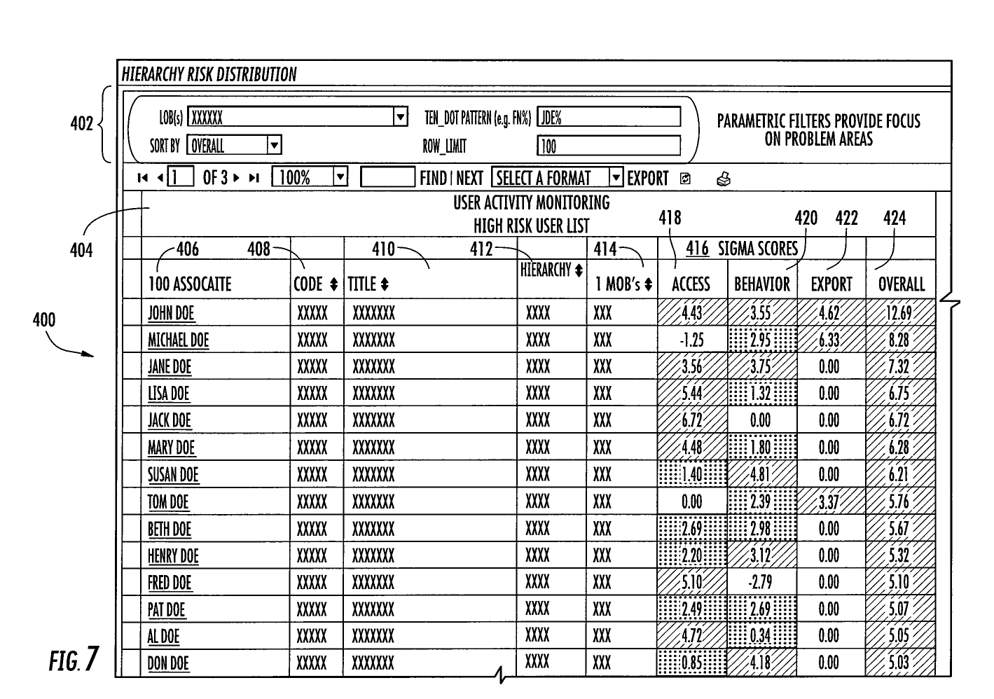

Referring to FIG. 7 shown is another graphical user interface (GUI) display 400 in a system for risk assessment review, in accordance with an embodiment of the present invention. Specifically, FIG. 7 depicts a report of “high risk users” used to identify risk review candidates, the list shown in FIG. 7 may be accessed by clicking-on or otherwise activating the link associated with the level/community displayed in the hierarchy columns of FIG. 6. Further, the GUI display 400 depicts how rules can be written to select candidates based upon thresholds.

The top portion 402 of the GUI display 400 allows for the user to filter the high risk user list further based on various parameters. The columns in the high risk user list 404 represent user/employee name 406, job code 408, job title 410, hierarchy 412, line of business 414 and the like. The normalized risk score columns 416 provide for risk category normalized scores, such as access normalized score 418, behavior normalized score 420 and export normalized score 422 and an overall outlier reinforcement score. i.e., the overall score 422. The normalized risk score columns 416 are sortable to provide for listing, in descending or ascending order the risk within a specified risk category or overall risk. In addition, the users/employees 406 displayed in the high risk user list 404 provides for links to a risk scorecard detail for that particular use/employee.

In the illustrated example of FIG. 7, thresholds have been set to indicate different levels of scores. For example, scores equal to or less than zero are indicated with no pattern, scores between zero and three are indicated by a dot pattern and scores greater than three are indicated by a cross-hatching pattern. A rule for automated selection operates in a similar manner, selecting scores greater than zero (including scores greater than three) as risk review candidates. Thus, those entries indicated by the dot pattern (i.e., between zero and three) and the cross-hatching pattern (i.e., greater than three) would be risk review candidates

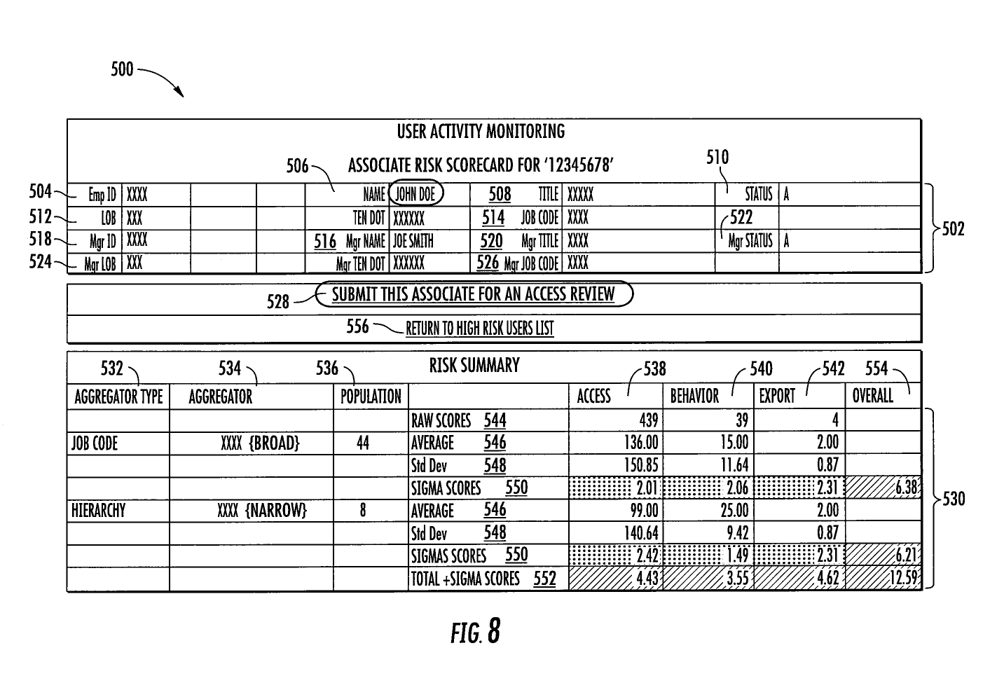

Turning the reader's attention to FIG. 8, shown is a graphical user interface display 500 in a system for risk assessment review in accordance with embodiments of the present invention. Specifically, FIG. 8 depicts a user/employee risk scorecard for a specific user/employee within the entity, “John Doe”, employee number “12345678”. The user/employee risk scorecard may be accessed by clicking-on or otherwise activating the link associated with the user/employee name in the “high risk user” list shown in FIG. 7.

The top portion 502 of the graphical user interface of FIG. 8 provides for user/employee identifying information such as employee number 504, name 506, employee job title 508, employee job status 510, employee line of business 512, employee job code 514, manager name 516, manager identification 518, manager title 520, manager job status 522, manager line of business 524, manager job code 526 and the like. The display also provides for a link 528 to submit the user/employee for a risk review, which adds the user/employee to the risk review queue. In the instances that automated rules are employed to make selections for risk review based on predetermined thresholds, the rule decisions may require verification, at least at the onset of the automated selection process, to ensure the correct decisions for review are being made.

The risk summary portion 530 of the user/employee risk scorecard provides columns for community category, i.e., aggregator type 532; community, i.e., aggregator 534; and the population within the community 536. In addition the risk summary portion includes raw risk scores 544 for each risk score category, i.e., access 538, behavior 540 and export 542. For each risk category, the community (i.e., aggregator) average 546, the community standard deviation 548, the community sigma score 550 (i.e., the number of standard deviations away from average) and the community category/aggregator type sigma score 552 (i.e., the summed total of all positive valued sigma scores for the individual communities within the community category) are depicted in the rows. In addition, a column for overall 554 provides for overall community sigma score (i.e., the sum of the individual risk category sigma scores) and overall community type sigma score (i.e., the sum of the community sigma scores).

In addition, a link 556 is provided in the display 500 of FIG. 8 that is operable to return to the “high risk user” list, shown in FIG. 7.

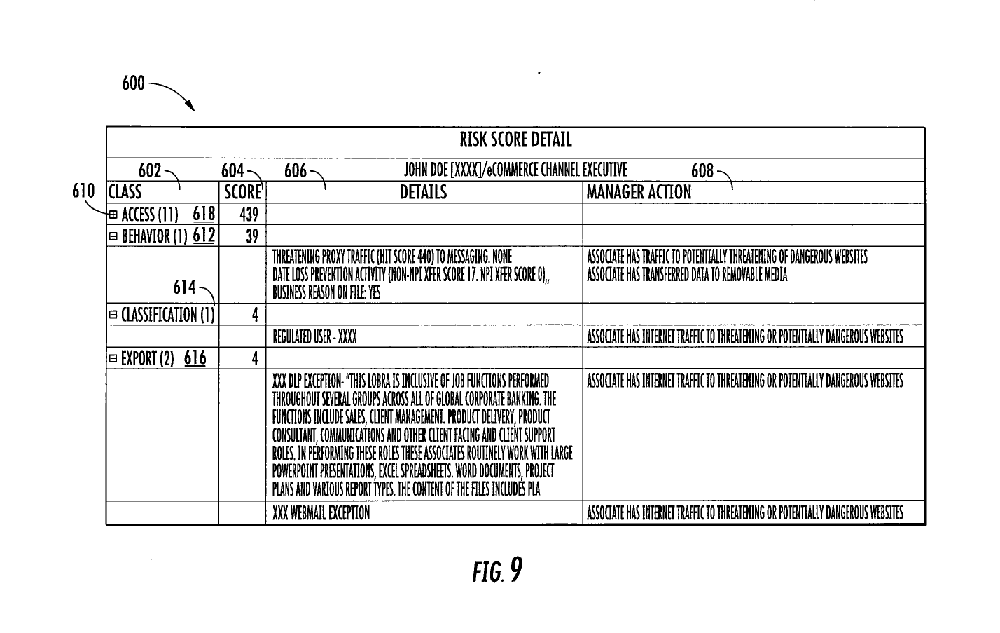

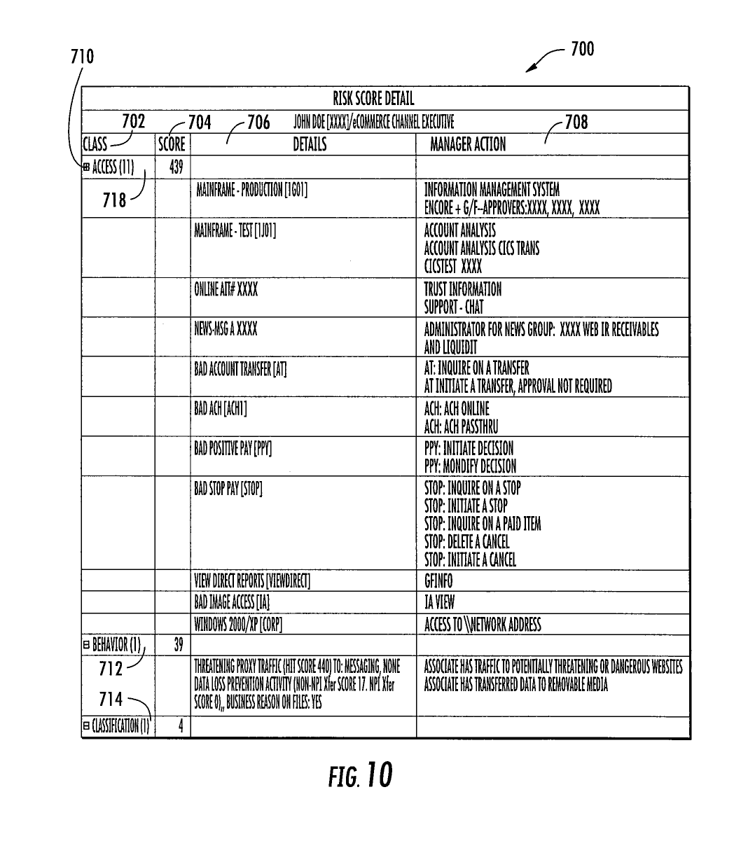

Referring to FIGS. 7 and 8 depicted are further graphical user interface displays 600 and 700 in a system for risk assessment review, in accordance with a further embodiment of the invention. Specifically, FIGS. 7 and 8 show risk score details associated with a specified user/employee, “John Doe”. The displays 600 and 700 of FIGS. 7 and 8 can be accessed by clicking-on or activating an appropriate link in the display shown in FIG. 8. The risk score details includes columns for the risk category (i.e., classification) 602/702, the raw risk category score 604/704, the details of the risk activity associated with the category 606/706 and the actions taken by the manager in light of the risk detail/activity 608/708. The risk detail 606/706 and manager action fields 608/708 are collapsible fields accessible by clicking-on the plus sign 610/710 located next to the risk category name. In the display shown in FIG. 9 behavior 612, classification 614 and export 616 risk categories have been activated to display the risk details 606 and manager actions 608 associated with these categories. The access 618 risk category has not been activated and, thus, risk details 606 and manager actions 608 are not displayed for this risk category. In the display shown in FIG. 10, the access 718 risk category has been activated to display the eleven access-related details/activities 706 and the associated manager actions 708. Once an analyst has reviewed the risk score details for a specified user/employee, the analyst can choose to submit the user/employee for risk review. In addition, the displays shown in FIGS. 7 and 8 can be used to verify the appropriateness of selections made by a set of automated rules.

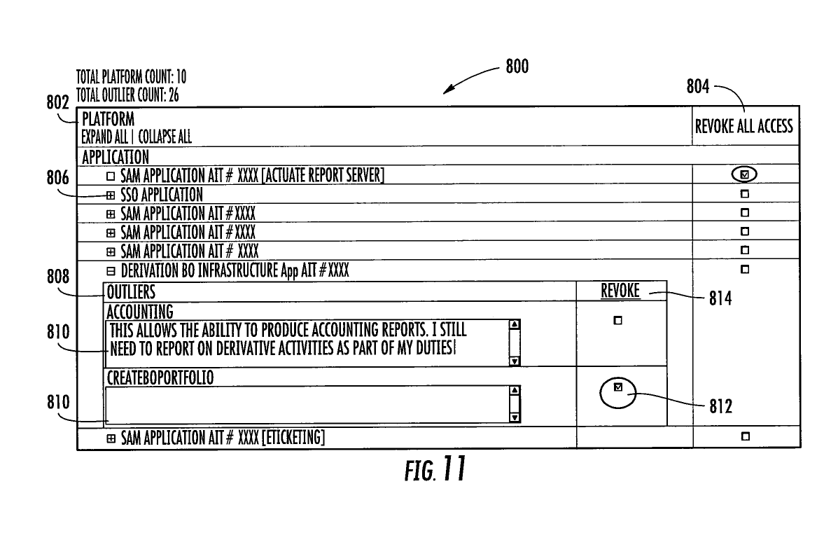

Referring to FIGS. 9 and 10 depicted are further graphical user interface displays 800 and 900 in a system for risk assessment review, in accordance with a further embodiment of the invention. Specifically, FIG. 11 shows a user/employee review display, in which the user's/employee's entitlements are displayed and the user/employee is tasked with provided justifications for their respective entitlements. FIG. 11 displays the platforms 802, i.e., the applications, servers, domains and the like, which the user/employee has been granted entitlement to use. If the user/employee deems a platform as not appropriate or necessary for job duties, the user/employee may revoke access to the platform in total by checking the box in the “revoke all access” column 804. Each platform displayed may be expanded by clicking-on or otherwise activating the plus key 806 displayed to the left of the platform. The expanded view provides for a listing of the individual unusual entitlements (i.e., outliers) associated with the platform and a field for user/employee justification inputs. The user/associate is tasked with providing justification for all entitlements or requesting that the entitlement be revoked. In certain embodiments of the invention, in the event no justification is provided by the user/associate, the unusual entitlement/outlier may be revoked. Such automatic revocation in the absence of justification is typically a policy decision of the risk-managing entity, enterprise, company or the like.

In the illustrated example of FIG. 11, the application entitled “Derivation Bo Infrastructure” has been expanded to provide the listing of individual outliers 808. The user/associate provides justification inputs into the entry fields 810 associated with the displayed outliers, i.e., “accounting and “creatboportfolio” or checks the box 812 under the revoke column 814 to request revocation of the entitlement.

It certain embodiments of the invention, if the user/employee fails to complete the review or fails to complete the review within a predefined time period, all of the unusual entitlements/outliers will be revoked. Such automatic revocation of all the unusual entitlements/outliers in the event that the user/employee fails to complete the review is typically a policy decision of the risk-managing entity, enterprise, company or the like. Once the user/employee has completed reviewing and provided justifications of their entitlements, the manager reviews the user's/employee's responses and has the authority to change the entitlements as need requires.

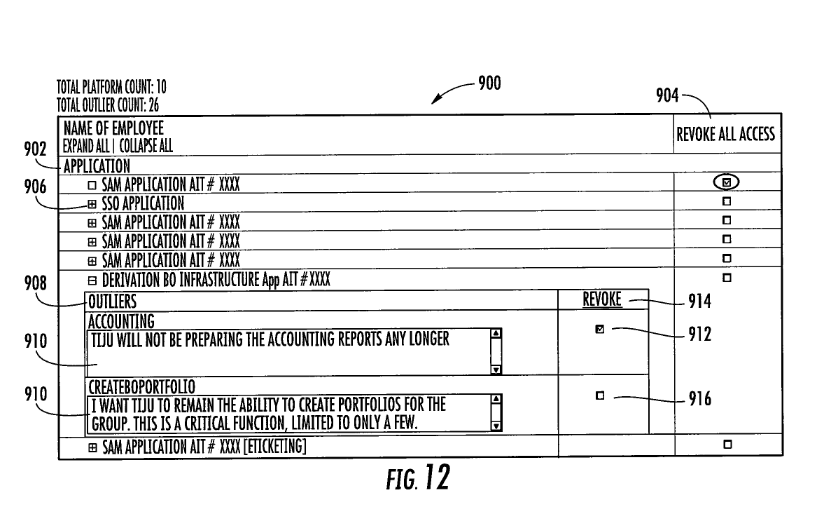

FIG. 12 shows the manager review display 900, in which the manager or facilitator is presented with the outlier entitlements associated with a user/employee and is tasked with review of the associate's responses. The manager will either confirm or deny the justifications; denial of a justification is in the form of revocation of the entitlement. FIG. 12 displays the platforms 902, i.e., the applications, servers, domains and the like, which the user/employee has been granted entitlement to use. If the manager deems a platform as not appropriate or necessary for job duties of the use/employee, the manager may revoke access to the platform in total by checking the box in the revoke all access column 904. In the illustrated example of FIG. 12, the manager/facilitator has accepted the user/employees request to revoke the entitlement associated with Application “SAM Application AIT #2836” as evident by the box in the revoke all access column remaining as checked. Each platform/application displayed may be expanded by clicking-on or otherwise activating the plus key 906 displayed to the left of the platform. The expanded view provides for a listing of the individual unusual entitlements/outliers associated with the platform and displays the user/employee justification inputs.

In the illustrated example of FIG. 12, the application entitled “Derivation Bo Infrastructure” has been expanded to provide the listing of individual outliers 908. The manager/facilitator has overridden the user/employee responses shown in FIG. 11. Specifically, the manager/facilitator has checked the box 912 under the revoke column 914 to request revocation of the “accounting” entitlement and has provided a revocation justification input into the corresponding entry field 910. In addition, the manager/facilitator has un-checked the box 916 to override the user/employees request for revocation of the “createboportfolio” entitlement and provided an entitlement justification into the corresponding entry field 910.

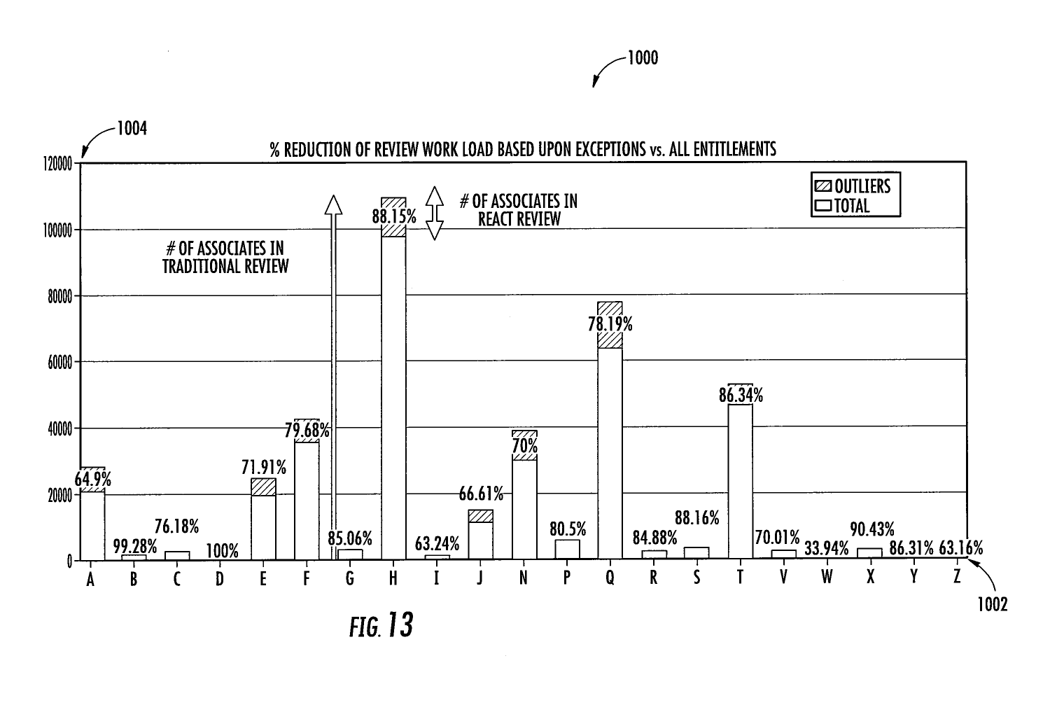

Referring to FIGS. 11 and 12 bar graphs 1000 and 1100 are shown that illustrate the success of implementing the outlier determination and risk review assessment process of the present invention. Each letter across the x-axis 1002 represents a hierarchy within the entity/corporation. In FIG. 13, the y-axis 1004 represents the number of users/employees. The overall height of each bar represents the total number of users/employees in the hierarchy and, since, traditional access reviews encompassed all of the users/employees, also represents the total number of access reviews that would traditionally be performed. The cross-hatched patterned portion of each bar represents the number of user/associates determined to be outliers in accordance with the determination process herein described. Hence, the cross-hatched patterned portion of each bar represents the users/employees requiring access review based on implementation of the system herein described. In general, less than about twenty percent of the users/employees in any one hierarchy are determined to be outliers warranting access review.

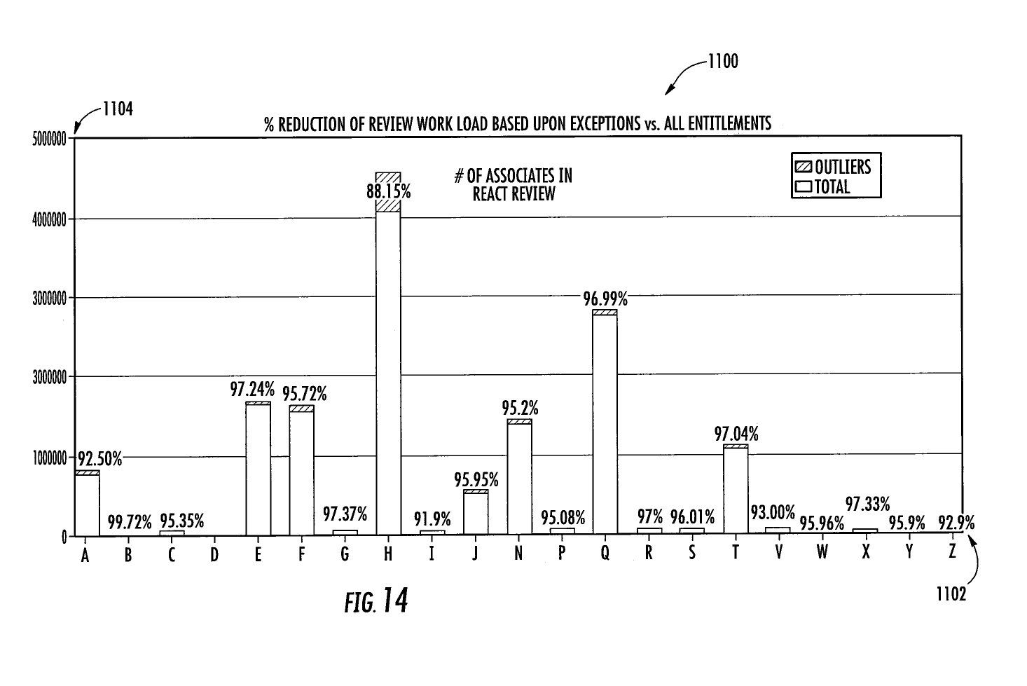

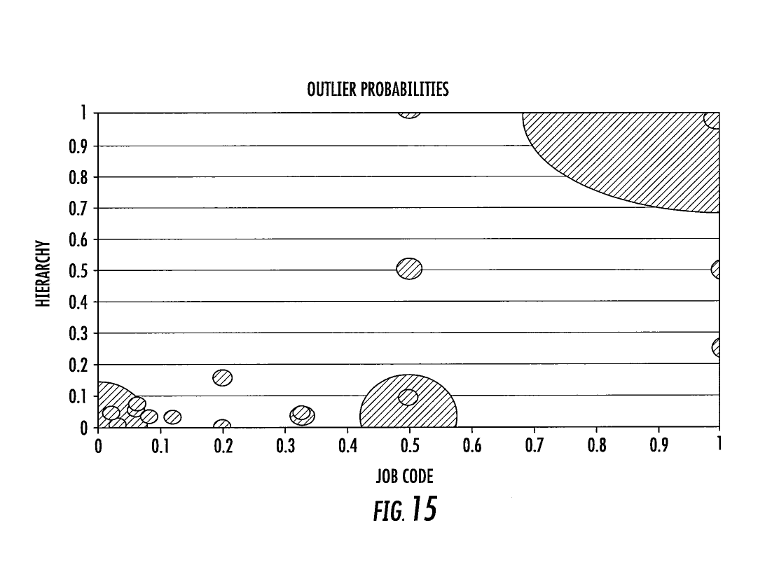

In the bar graph 1100 of FIG. 14, the overall height of each bar represents the total number of entitlements in the hierarchy and since traditional access reviews encompassed all of the entitlements, the total height of the bar also represents the number of entitlements traditionally reviewed. The cross-hatch patterned portion of each bar represents the number entitlements requiring review based on implementation of the system herein described. In general, as illustrated in FIG. 15 and discussed infra., less than about five percent of the entitlements are outliers that warrant access review.

Referring to FIG. 15 a bubble chart is depicted that illustrates that the overall probability of an outlier is a function of the probabilities for the two identified community categories; specifically, hierarchy and job code, in accordance with embodiments of the present invention. Outlier probability calculations are designed to reduce false positives in the outlier detection process and to amplify outliers observed in both hierarchy and job code community categories. The overall probability of the outlier is a product of probabilities for the two community categories (i.e., hierarchy and job code), and the shaded area on the outlier plot represents overall probability greater than 68% of the entitlement being an outlier. The outlier plot shows that there is a clear separation between true outliers and some entitlements that seem unusual in one community category (e.g., job code), but shared by more than one associate in another community category (e.g., hierarchy), which significantly increases confidence level of the process.

Thus, present embodiments herein disclosed provide for a streamlined and efficient approach to risk entitlement reviews. The methods herein described limit the number of users/employees requiring reviews, the number of managers required to perform access entitlement reviews and number of individual entitlements required to be reviewed. In addition, by streamlining the process so that only those users/employees identified as outliers require access entitlement review, a greater completion rate is realized and a higher rate of entitlement revocations is realized.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. A method for risk review candidate determination, the method comprising:
identifying two or more community categories within an entity;
determining, via a computing device processor, for a plurality of employees associated with the entity, one or more raw risk scores, wherein each raw risk score is associated with a risk category;
determining, via a computing device processor, community averages and community standard deviations for each community within the community categories based on the one or more raw risk scores;
determining, via a computing device processor, for the plurality of employees, one or more normalized risk scores, wherein each normalized risk score is based on the raw risk score and associated with a corresponding risk category and a corresponding community; and
determining, via a computing device processor, one or more risk review candidates from amongst the plurality of employees by comparing the normalized risk scores to predetermined normalized risk score thresholds.

2. The method of claim 1, further comprising determining, via a computing device processor, for each of the plurality of employees, an outlier reinforcement score.

3. The method of claim 2, wherein determining an outlier reinforcement score further comprises determining, via the computing device processor, for each of the plurality of employees, the outlier reinforcement score wherein the outlier reinforcement score is determined by summing all of the positive-valued normalized risk scores within a community to result in an overall community score and summing all of the overall community scores to result in the outlier reinforcement score.

4. The method of claim 2, wherein determining the one or more risk review candidates further comprises determining, via a computing device processor, the one or more risk review candidates by comparing the outlier reinforcement score to a predetermined outlier reinforcement score threshold.

5. The method of claim 1, wherein identifying further comprises identifying two community categories within the entity, wherein a first community category is characteristically broad and a second community category is characteristically narrow.

6. The method of claim 1, wherein identifying further comprises identifying two community categories within the entity, wherein each community category comprises a plurality of communities and each of the plurality of employees belong to one community within the community category.

7. The method of claim 1, wherein determining the one or more raw risk scores further comprises determining, via the computing device processor, for the plurality of employees associated with the entity, the one or more raw risk scores, wherein each raw risk score is associated with a risk category and the risk categories include access, behavior and export.

8. The method of claim 1, wherein determining the plurality of normalized risk scores further comprises determining, via the computing device processor, for the plurality of employees, the plurality of normalized risk scores, wherein the normalized risk scores are standard z-scores.

9. The method of claim 1, wherein determining the plurality of normalized risk scores further comprises determining, via the computing device processor, for the plurality of employees, the plurality of normalized risk scores, wherein the normalized risk score for a risk category equals the difference between a raw risk score and the community average divided by the community standard deviation.

10. An apparatus for risk review candidate determination, the apparatus comprising:
a computing platform including a memory and at least processor in communication with the memory;
a risk outlier module stored in the memory, executable by the processor and including:
one or more risk category score routines configured to determine, for a plurality of employees associated with an entity, a raw risk score;
a community average and standard deviation routine configured to determine, community averages and community standard deviations for each community within two or more identified community categories, wherein the community averages and community standard deviations are determined based on the raw risk score;
a risk score normalization routine configured to determine, for the plurality of employees, one or more normalized risk scores, wherein each normalized risk score based on a raw risk score and is associated with a risk category and a community; and
a risk review candidate determination routine configured to determine one or more risk review candidates from amongst the plurality of employees by comparing the normalized risk scores to predetermined normalized risk score thresholds.

11. The apparatus of claim 10, wherein the risk outlier module further comprises an outlier reinforcement routine configured to determine, for each of the plurality of employees, an outlier reinforcement score.

12. The apparatus of claim 11, wherein the outlier reinforcement routine is further configured to determine the outlier reinforcement score by summing all of the positive-valued normalized risk scores within a community to result in an overall community score and summing all of the overall community scores to result in the outlier reinforcement score.

13. The apparatus of claim 11, wherein the risk review candidate determination routine is further configured to determine the one or more risk review candidates by comparing the outlier reinforcement score to a predetermined outlier reinforcement score threshold.

14. The apparatus of claim 10, wherein the community average and standard deviation routine is further configured to determine community averages and community standard deviations for each community within two identified community categories, wherein a first community category is characteristically broad and a second community category is characteristically narrow.

15. The apparatus of claim 10, wherein the community average and standard deviation routine is further configured to determine community averages and community standard deviations for each community within two identified community categories, wherein each community category comprises a plurality of communities and each of the plurality of employees belong to one community within the community category.

16. The apparatus of claim 10, wherein the one or more risk category score routines configured are further configured to determine a raw access risk score, a raw behavior risk score and raw export risk score.

17. The apparatus of claim 10, wherein the risk score normalization routine is further configured determine, for the plurality of employees, the plurality of normalized risk scores, wherein the normalized risk scores are standard z-scores.

18. The apparatus of claim 10, wherein the risk normalization routine is further configured to determine, for the plurality of employees, the plurality of normalized risk scores, wherein the normalized risk score for a risk category equals the difference between a raw risk score and the community average divided by the community standard deviation.

19. A computer program product comprising:
a non-transitory computer-readable medium comprising:
a first set of codes for causing a computer to determine, for a plurality of employees associated with the entity, one or more raw risk scores, wherein each raw risk score is associated with a risk category;
a second set of codes for causing a computer to determine community averages and community standard deviations for each community within two or more identified community categories based on the one or more raw risk scores;
a third set of codes for causing a computer to determine, for the plurality of employees, one or more normalized risk scores, wherein each normalized risk score is based on a raw risk score and associated with a risk category and a community; and
a fourth set of codes for causing a computer to determine one or more risk review candidates from amongst the plurality of employees by comparing the normalized risk scores to predetermined normalized risk score thresholds.

20. The computer program product of claim 19, further comprising a fifth set of codes for causing a computer to determine, for each of the plurality of employees, an outlier reinforcement score.

21. The computer program product of claim 20, wherein the fifth set of codes is further configured to cause the computer to determine, for each of the plurality of employees, the outlier reinforcement score by summing all of the positive-valued normalized risk scores within a community to result in an overall community score and summing all of the overall community scores to result in the outlier reinforcement score.

22. The computer program product of claim 20, wherein the fourth set of codes is further configured to cause the computer to determine the one or more risk review candidates by comparing the outlier reinforcement score to a predetermined outlier reinforcement score threshold.

23. The computer program product of claim 19, wherein the second set of codes is further configured to cause the computer to determine community averages and community standard deviations for each community within two identified community categories, wherein a first community category is characteristically broad and a second community category is characteristically narrow.

24. The computer program product of claim 19, wherein the second set of codes is further configured to cause the computer to determine community averages and community standard deviations for each community within two or more identified community categories, wherein each community category comprises a plurality of communities and each of the plurality of employees belong to one community within the community category.

25. The computer program product of claim 19, wherein the first set of codes is further configured to cause the computer to determine, for the plurality of employees associated with the entity, the one or more raw risk scores, wherein each raw risk score is associated with a risk category and the risk categories include access, behavior and export.

26. The computer program product of claim 19, wherein the third set of codes is further configured to cause the computer to determine, via the computing device processor, for the plurality of employees, the plurality of normalized risk scores, wherein the normalized risk scores are standard z-scores.

27. The computer program product of claim 19, wherein the third set of codes is further configured to cause the computer to determine, for the plurality of employees, the plurality of normalized risk scores, wherein the normalized risk score for a risk category equals the difference between a raw risk score and the community average divided by the community standard deviation.
